(19) United States
(12) Patent Application Publication
(10) Pub. No.: US 2026/0307381 A1
(43) Pub. Date: Oct. 8, 2026

(54) PROCESS FOR THE PREPARATION OF A BONDED STRUCTURE, A BONDED STRUCTURE AND USE OF SAID BONDED STRUCTURE FOR PREPARING AN AUTOMOTIVE PART

(71) Applicant: SABIC GLOBAL TECHNOLOGIES B.V., Bergen op Zoom (NL)

(72) Inventors: Jana HRACHOVA, Sittard (NL); Hans LEENDERS, Bergen op Zoom (NL)

(21) Appl. No.: 19/483,288

(22) PCT Filed: May 17, 2024
(86) PCT No.: PCT/EP2024/063813

§ 371 Date: Nov. 11, 2025

Related U.S. Application Data
(60) Provisional application No. 63/467,760, filed on May 19, 2023.

(30) Foreign Application Priority Data
Sep. 6, 2023 (EP) 23195619.4

(51) Int. Cl. B32B 37/12; B32B 15/085; B32B 15/20; B32B 27/08; B32B 27/16; B32B 27/20; B32B 27/32

(52) U.S. Cl. CPC B32B 37/12; B32B 15/085; B32B 15/20; B32B 27/08; B32B 27/16; B32B 27/20; B32B 27/32; B32B 2037/1253; B32B 2250/02; B32B 2262/101; B32B 2309/02; B32B 2309/04; B32B 2310/0454; B32B 2310/0463; B32B 2310/0843; B32B 2311/24; B32B 2323/04; B32B 2323/10

(57) ABSTRACT

A process for preparing of a bonded structure includes flame-treating a surface of a first part including a polyolefin to provide an activated polyolefin surface; directly applying an acrylic structural adhesive to the activated polyolefin surface and a surface of a second part; and curing the adhesive to form a bond between the first part and the second part.

### CROSS REFERENCE TO RELATED APPLICATIONS

This application is a National Stage application of PCT/EP2024/063813, filed May 17, 2024, which claims the benefit of U.S. Provisional Application No. 63/467,760, filed May 19, 2023 and European Application No. 23195619.4, filed Sep. 6, 2023, all of which are incorporated by reference in their entirety herein.

### BACKGROUND

Polymeric materials can be bonded by means of a bonding agent that is applied to the bonding surfaces of the materials to be bonded. This requires deposition of the bonding agent onto the bonding surfaces of the polymeric materials. Adhesion of the bonding agent to the bonding surfaces might be difficult to accomplish due to the inherent incompatible chemical nature of the two materials (bonding agent versus polymeric material).

For example, it can be difficult to adhere a polyolefin, e.g., a polypropylene, surface to another surface, e.g., another polyolefin surface, due to, for example, low surface energy and low polarity of the polyolefin. For example, acrylic adhesives may be not recommended for adhering a polyolefin surface to another surface.

Therefore, there is a need for an improved method for the preparation of a bonded structure having desirable bond strength.

### OBJECTS OF THE INVENTION

It is an object of the present invention to provide a process for improved bonding.

It is another object of the present invention to provide a bonded structure that is suitable for preparing an automotive part.

### SUMMARY OF THE INVENTION

Provided is a process for preparing of a bonded structure comprising flame-treating a surface of a first part comprising a polyolefin to provide an activated polyolefin surface; directly applying an acrylic structural adhesive to the activated polyolefin surface and a surface of a second part; and curing the adhesive to form a bond between the first part and the second part.

The acrylic structural adhesive can comprise methacrylate. The polyolefin can comprise a polypropylene. The polyolefin can comprise a polyethylene. The first part can further comprise glass fiber. The first part can further comprise a flame retardant additive.

The first part can further comprise a combination of glass fiber and a flame retardant additive.

The second part can comprise a polyolefin. The bond can have a lap shear strength according to DIN EN 1465:2009 of greater than or equal to 1.5 megapascals (MPa) or 1.75 MPa after conditioning for 168 hours at 23±2° C. and 50±6% relative humidity.

The bond can have a lap shear strength according to DIN EN 1465:2009 of greater than or equal to 2.0 MPa or 2.25 MPa after conditioning for 168 hours at 23±2° C. and 50±6% relative humidity and being subjecting to heating and cooling cycles at various relative humidities.

The second part can comprise a polypropylene. The second part can comprise a polyethylene.

The second part can comprise a metal. The second part may not be subjected to laser radiation. The bond can have a lap shear strength according to DIN EN 1465:2009 of greater than or equal to 2.0 MPa or 2.25 MPa or 2.5 MPa after conditioning for 168 hours at 23±2° C. and 50±6% relative humidity. The bond can have a lap shear strength according to DIN EN 1465:2009 of greater than or equal to 6.0 MPa or 6.25 MPa or 6.5 MPa after conditioning for 168 hours at 23±2° C. and 500±6% relative humidity and being subjecting to heating and cooling cycles at various relative humidities. The bond can have a lap shear strength according to DIN EN 1465:2009 of greater than or equal to 6.0 MPa or 6.25 MPa or 6.5 MPa after conditioning for 168 hours at 23±2° C. and 50±6% relative humidity and being fully immersed in ethylene-glycol/water for 45 days at 65° C.

Said propane-comprising gas can comprise at least 80 weight percent (wt. %) of propane based on a weight of the propane-comprising gas, wherein, during treatment with the flame of the propane-comprising gas, a flame is produced by burning a mixture of air and the propane-comprising gas.

During treatment with the flame of the propane-comprising gas, a volume ratio of propane to oxygen is equal to or less than 1:5.01.

The activated polyolefin surface can have a surface energy of less than 34 millinewtons per meter, determined in accordance with ISO 8296:2003.

The acrylic structural adhesive can comprise two components.

Also provided is a bonded structure prepared by the process, for example, configured for use in a battery, for example, configured for use in a battery for an electric vehicle.

Further provided is electric vehicle comprising the bonded structure.

A process for the preparation of a bonded structure comprising at least a first polyolefin part having a first bonding surface can comprise the step of:
a) flame-treating at least part of a first bonding surface of said first polyolefin part with a flame of a propane-comprising gas, said propane-comprising gas being propane or a mixture comprising at least 50 wt. % of propane based on the weight of the propane-comprising gas with one or more gases selected from the group consisting of methane, ethane, butane, pentane, and hexane, wherein, during flame-treatment with a flame of the propane-comprising gas, a flame is produced by burning a mixture of air and the propane-comprising gas, wherein the gas-to-air ratio is chosen such that a volume ratio of propane to oxygen is equal to or less than 1:5.01, for example, less than 1:5.00 and preferably at least 1:3.50 to obtain a first polyolefin part having a flame-treated first polyolefin bonding surface.

The first polyolefin part may be prepared from a composition comprising polypropylene and long glass fibers, for example, from compositions as commercially available from SABIC under the trademark STAMAX™ polypropylene.

The first polyolefin part may be prepared from a composition comprising polypropylene and a mineral filler.

In another embodiment, the process further comprises the sequential steps of:
b1) providing a second part, wherein the second part has a second bonding surface and
c1) contacting said first and second bonding surfaces with an acrylic structural adhesive (3) together by contacting at least part of the flame-treated first polyolefin bonding surface and at least part of said second bonding surface with said acrylic structural adhesive.

The process of this embodiment, is in particular suitable for preparing a tailgate or a roof spoiler.

Before step c1), at least part of a second polyolefin bonding surface may be flame-treated with a flame of a propane-comprising gas, said propane-comprising gas being propane or a mixture comprising at least 50 wt. % of propane with one or more gases selected from the group consisting of ethane, butane, and hexane wherein, preferably during flame-treatment with a flame of the propane-comprising gas, a flame is produced by burning a mixture of air and the propane-comprising gas, wherein the gas-to-air ratio is chosen such that a volume ratio of propane to oxygen is equal to or less than 1:5.01, for example, less than 1:5.00 and preferably at least 1:3.50 to obtain a second polyolefin part having a flame-treated second polyolefin bonding surface.

The propane-comprising gas can comprise at least 80 wt. % of propane, preferably at least 95 wt. % of propane, more preferably at least 99 wt. % of propane, or even 100 wt. % based on the weight of the propane-comprising gas.

A burner may be used for producing the flame, said burner comprising at least one nozzle for providing a mixture of air and the propane-comprising gas to be burned, wherein the gap between the at least one nozzle and said first bonding surface and/or said second bonding surface is between 5 centimeters (cm) and 15 cm, preferably 8 cm.

The temperature reached on the said flame-treated first polyolefin bonding surface and/or flame-treated second boding surface during flame-treatment with a flame of a propane-comprising gas, may for example, be between 30° C. and 90° C., preferably between 50° C. and 80° C., more preferably between 60° C. and 65° C.

The surface energy of the flame-treated first polyolefin bonding surface and/or flame-treated second polyolefin bonding surface is preferably higher than 30 millinewtons per meter (mN/m), determined in accordance with ISO 8296:2003, and the polar part of the surface energy is preferably higher than 1.5 mN/m, preferably higher than 2 mN/m.

With “the first polyolefin part can comprise a polymer” is meant that the first polyolefin part comprises at least 35 wt. %, for example, at least 50 wt. %, for example, at least 75 wt. %, or at least 83 wt. % or even 99 wt. % or 100 wt. % of one or more polymers based on the weight of the first polyolefin part.

With “the second part can comprise a polymer” is meant that the second part comprises at least 35 wt. %, for example, at least 50 wt. %, for example, at least 75 wt. %, or at least 83 wt. % or even 99 wt. % or 100 wt. % of one or more polymers based on the weight of the second part.

The first polyolefin part and the second part may comprise the same polymer(s).

The polyolefin can be polypropylene or a combination of polypropylene and polyethylene, wherein preferably the polyolefin comprises at least 45 wt. % of polypropylene based on the total weight of the polyolefin.

In another aspect, the invention relates to a bonded structure obtainable or obtained by the process according to the invention.

In another aspect, the invention relates to a use of the bonded structure as an automotive part, for example, as a tailgate or roof spoiler or a bumper.

All embodiments specified for the processes according to the invention are also applicable for the products and their uses, unless otherwise specified.

### Definitions

The following definitions are used in the present description.
“Bonding agent”, as used in the present application, means a material capable of fastening two surfaces together, usually producing a smooth bond. A bonding agent is also known as an adhesive.
“Gap between the burner nozzle(s) and the surface”, as used in the present application, means the distance between the burner nozzles and the surface to be flame-treated, for example, the surface of a polyolefin part.
“Gas-to-air ratio”, as used in the present application, means, the ratio of parts of gas to parts of air used in a flame, i.e., in the total gas and air flow. Unless otherwise specified, the ratio is a volume ratio. For example, 1:17, means that for 1 liter (L) of gas fed to the flame 17 L of air is used as oxidizer.
“Flame-treatment speed”, as used in the present application, means, the length of a surface that is exposed to the flame per unit time; for example, the length of the surface of a polyolefin part per unit time that is exposed to the flame. In this sense, a flame-treatment speed of 300 millimeters per second (mm/s) means that 300 millimeters (mm) of the surface of, e.g., a polyolefin part, is exposed to the flame per second.
“Total flow of gas and air mixture”, as used in the present application, means the liters per unit time of the mixture gas and air that is fed to the burner in order to produce the flame. For example, a total flow of gas and air mixture of 300 liters per minute (L/min), means that 300 liters of gas and air mixture are fed to the burner in order to produce the flame.
“Activation of the surface or surface activation”, as used in the present application, means, modification of the surface chemistry of a solid, e.g., a polyolefin part, leading to an increase of its surface energy (also known as surface free energy (SFE)), an increase of the polar part contributing to the surface energy, and/or a decrease of the contact angle of the surface with water.
“Surface energy”, as used in the present application, means the surface energy calculated according to the Owens, Wendt, Rabel and Kaelble method, which is a standard method for calculating the surface energy of a solid from the contact angle with two liquids water, diiodomethane. This allows for the determination of the surface energy, which is divided into a polar part and a disperse (or dispersive) part. Based on the theory by Owens, Wendt, Rabel and Kaelble, the surface tension (o) can be divided into a polar and disperse part as follows:

$${σ}_{l} = {σ}_{l}^{P} + {σ}_{l}^{D} and \qquad ( 1 )$$

$${σ}_{s} = {σ}_{s}^{P} + {σ}_{s}^{D}$$

with P for polar, D for disperse and s for solid and l for liquid.

$${σ}_{s} = {γ}_{sl} + {σ}_{l} \cdot cos θ$$

It is well known that, according to Young, the correlation of the surface tension between the solid and the liquid, σ_{s,l}, the surface energy between the solid and the liquid γₛₗ and the contact angle θ can be described as follows:

$${σ}_{s} = {γ}_{sl} + {σ}_{l} \cdot cos θ \qquad ( 2 )$$

Owens and Wendt hypothesized the following equation for the surface energy:

$${γ}_{sl} = {σ}_{s} + {σ}_{l} - 2 \cdot ( \sqrt{{σ}_{s}^{D} \cdot {σ}_{l}^{D}} + \sqrt{{σ}_{s}^{P} \cdot {σ}_{l}^{P}} ) \qquad ( 3 )$$

The combination of equations (2) and (3) leads to the following linear equation:

$$\frac{( 1 + cos θ ) \cdot {σ}_{l}}{2 \sqrt{{σ}_{l}^{D}}} = \sqrt{{σ}_{s}^{D}} + \sqrt{{σ}_{s}^{P}} \sqrt{\frac{{σ}_{l}^{P}}{{σ}_{l}^{D}}}$$

which can be written as

m=b+m·x (4)

By using a linear regression in an x-y coordinate system, σₛ^{P} can be estimated by the square of the slope m and σₛ^{D} can be estimated by the square of the ordinate intercept b.

To estimate the polar and disperse part, water and diiodomethane are used due to their diverse

$$\sqrt{{σ}_{l}^{P}} / \sqrt{{σ}_{l}^{D}} - ratio .$$

### BRIEF DESCRIPTION OF THE DRAWINGS

Having thus described aspects of the disclosure in the foregoing general terms, reference will now be made to the accompanying figures, which are not necessarily drawn to scale, and wherein:

FIG. 1 illustrates a setup for lap shear testing in accordance with the Examples.

FIG. 2 illustrates failure types of adhesive bonds (DIN EN ISO 10365).

FIG. 3 is a graph showing the results of Table 2.

FIG. 4 is a graph showing the results of Table 3.

FIG. 5 is a graph showing the results of Table 4.

FIG. 6 is a graph showing the results of Table 4.

### DETAILED DESCRIPTION

The present application relates in a first aspect to a process for the preparation of a bonded structure comprising at least a first polyolefin part having a first bonding surface, an acrylic structural adhesive and a second part having a second bonding surface, wherein said first and second bonding surfaces are in contact with said acrylic structural adhesive, said process preferably comprising the steps of:
a) flame-treating at least part of a first bonding surface of said first polyolefin part with a flame of a propane-comprising gas, said propane-comprising gas being propane or a mixture comprising at least 50 wt. % of propane based on the weight of the propane-comprising gas with one or more gases selected from the group consisting of methane, ethane, butane, pentane, and hexane to obtain a first polyolefin part having a flame-treated first polyolefin bonding surface;
b) providing a second part having a second bonding surface;
c) bonding said first polyolefin part and said second part together by contacting at least part of the flame-treated first polyolefin bonding surface and at least part of said second bonding surface with said acrylic structural adhesive.

With the process according to the invention a bonded structure having high adhesion shear strength is obtained. The bonding surface of at least a first polyolefin part is activated, and good adhesion between the acrylic structural adhesive and the bonding surfaces is obtained.

Before step c1), at least part of a second polyolefin bonding surface may be treated with a flame of a propane-comprising gas, said propane-comprising gas being propane or a mixture comprising at least 50 wt. % of propane with one or more gases selected from the group consisting of ethane, butane, and hexane to obtain a second part having a flame-treated second polyolefin bonding surface.

The first bonding surface can be washed before performing step a) of the method according to the invention. The second bonding surface can also be washed before bonding this to the first polyolefin part or before subjecting this to a treatment with a flame of propane-comprising gas. The second bonding surface may also be activated using a different activation method, by treating said surface with e.g., atmospheric plasma, low pressure plasma, with a corona-treatment or by fluorination.

The washing step can be performed by immersing the polyolefin part in a solution comprising a cleansing agent, such as a surfactant. The washing step can also comprise immersing the polyolefin part in a solvent, such as an alcohol, preferably an alcohol chosen from the group of propanol, isopropyl alcohol, more preferably isopropyl alcohol with a purity higher than 96 wt. %.

The washing step can be substituted by a cleaning step, which comprises applying a solution comprising a cleansing agent or a solvent to the bonding surface, optionally followed by rinsing said surface with water.

With at least part of a first bonding surface is treated, or at least part of a second bonding surface is treated, is meant that preferably at least 80%, more preferably at least 90%, even more preferably at least 95% or even at least 99% or 100% of the first bonding surface or the second bonding surface is treated, respectively.

It will be understood that the bigger the surface of the bonding surface that is treated, the better the surface is activated and as a consequence adhesion of the bonding surface with an acrylic structural adhesive is improved, and a bonded structure with high adhesion shear strength is obtained.

A primer need not be applied on the flame-treated first polyolefin bonding surface and/or the (flame-treated) second bonding surface before performing step c1) to ensure suitable adhesion.

A primer, which is also known as an adhesion promoter, need not be applied onto a bonding surface before contacting the surface with an acrylic structural adhesive, in order to ensure suitable adhesion of the acrylic structural adhesive to the bonding surface.

Without use of a primer, acrylic structural adhesive can be directly applied to an activated polyolefin surface and a surface of a second part.

The present inventors surprisingly discovered that while acrylic adhesives may not be recommended for adhering a polyolefin surface to another surface, flame-treating the polyolefin, e.g., polypropylene, surface, as disclosed herein, can result in a surface energy that provides desirable adhesion, both initially and long term, between the polyolefin and a second part, for example, comprising a polyolefin, e.g., polypropylene, or metal, using an acrylic structural adhesive.

In the present application a first bonding surface can also be a first bonding surface that has been washed or cleaned.

In the present application a second bonding surface can also be a second bonding surface that has been washed or cleaned. Moreover, a second bonding surface can also be a second polyolefin bonding surface that has been flame-treated, i.e., flame-treated second polyolefin bonding surface.

The flame-treatment can be performed using a burner for producing the flame. The burner is fed with a defined mixture of a fuel (propane-comprising gas) and an oxidizer (air), thoroughly premixed before combustion. In the flame-treatment, during the application of heat by the flame, bonds between atoms and/or molecular chains are broken up on the surface and oxygen contents contained in the flame are bound to the breaking point. In this way polar molecules arise on the surface of the original non-polar material. The mechanical properties of the surfaces do not change.

Variables affecting the flame-treatment are for example, the gas-to-air ratio, the composition of the gas, the gap between the burner nozzles and the bonding surface, the flame-treatment speed, and the total flow of gas and air mixture. These variables affect the temperature reached on the flame-treated bonding surface during the flame-treatment.

The present applicants have observed that by using a propane-containing gas being propane or a mixture comprising at least 50 wt. % of propane the bonding surface of polyolefin parts is activated. Preferably, the propane-comprising gas comprises at least 80 wt. % of propane, more preferably at least 95 wt. % of propane, such as for example, at least 99 wt. % of propane or even 100 wt. % of propane.

During treatment with a flame of a propane-comprising gas, a flame is produced by burning a mixture of air and the propane-comprising gas, wherein the gas-to-air ratio is chosen such that a volume ratio of propane to oxygen is equal to or less than 1:5.01. This also contributes to a further activation of the bonding surface of a polyolefin part.

A propane to oxygen volume ratio within the disclosed range can provide, for example, a surface energy of the activated polyolefin, e.g., polypropylene, surface, to be bonded to a second part using an acrylic structural adhesive, of higher than 30 and less than 34 mN/m, determined in accordance with ISO 8296:2003, the benefits of which are disclosed herein.

The polyolefin parts, i.e., first polyolefin part and/or second polyolefin part, can comprise a polyolefin chosen from the group of propylene-based polymers (polypropylenes), elastomers of ethylene and α-olefin comonomer having 4 to 8 carbon atoms, and any mixtures thereof. Preferably, the polyolefin comprises a propylene-based polymer. Preferably, the thermoplastic polymer composition comprises at least 80 wt. % of the propylene-based polymer, for example, at least 90 wt. %, at least 93 wt. %, at least 95 wt. %, at least 97 wt. % at least 98 wt. % or at least 99 wt. % of the propylene-based polymer based on the thermoplastic polymer composition. In a special embodiment, the thermoplastic polymer composition consists of the propylene-based polymer.

The propylene-based polymer can be at least one selected from the group consisting of a propylene homopolymer, a propylene random copolymer and a heterophasic propylene copolymer and mixtures thereof, preferably wherein the polyolefin comprises a propylene random copolymer; a propylene homopolymer and a heterophasic propylene copolymer; or a propylene homopolymer and a propylene random copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The random propylene copolymer may comprise as the comonomer ethylene and/or an α-olefin chosen from the group of α-olefins having 4 to 10 C-atoms, preferably ethylene, 1-butene, 1-hexene or any mixtures thereof. The amount of the comonomer is preferably at most 10 wt. % based on the random propylene copolymer, for example, in the range from 2 to 7 wt. % based on the random propylene copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers can be produced using any conventional technique known to the skilled person, for example, multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der en, Studies in Polymer Science 7, Elsevier 1990; WO06/010414, U.S. Pat. Nos. 4,399,054 and 4,472,524.

The polymers or thermoplastic materials may be linear polymers or branched polymers or combinations thereof. The plastic can optionally be reinforced, e.g., with fibers, particles, flakes, as well as combinations comprising at least one of the foregoing, such as especially for example, long glass fibers, short glass fibers, glass beads, talc, mica, inorganic fillers, natural fibers, conductive fillers and/or carbon fibers. For example, the thermoplastic second component can be formed from STAMAX® materials, a long glass fiber reinforced polypropylene commercially available from SABIC.

The polymer can comprise an additive, such as stabilizers, antioxidants, pigments; wherein the polymer preferably comprises at most 5% of the additive. The combination can be a blend or a copolymer. The polymer can be filled with a mineral filler, e.g., talc, or glass fibers; for example, the polymer can comprise at most 45 wt. % of the filler, such as for example, at most 40 wt. % of the filler, based on the total weight of the polymer. In an embodiment, the polymer can comprise a flame retardant additive such as a nitrogen-phosphorus based flame retardant.

In an embodiment, the polymer can comprise 20 to 40 wt. % or 25 to 30 wt. of long glass fibers; 20 to 40 wt. % or 25 to 30 wt. of short glass fibers; or 30 to 50 wt. % or 35 to 45 wt. % of long glass fibers.

The polymer can comprise a combination of glass fiber and a flame retardant additive.

The glass fibers used as filler in the polymer can be long and/or short glass fibers. Short glass fibers in the polymer may have an average length of up to 1.0 mm. Long glass fibers in the polymer may have an average length of 1.0 to 4.5 mm, for example, 2.0 to 4.0 mm. The diameter of the glass fibers can be 5.0 to 50.0 micrometers, specifically, 8.0 to 30.0 micrometers, more specifically, 10.0 to 20.0 micrometers. The lengths and the diameters of the glass fibers can be determined based on the photo images by an image analysis software. The term “average” refers to an arithmetic average.

For example, the polyolefin is polypropylene or a combination of polypropylene and polyethylene, wherein preferably the polyolefin comprises at least 45 wt. % of polypropylene based on the total weight of the polyolefin.

For example, the polyolefin parts, i.e., first polyolefin part and/or second part, comprise a polyolefin filled with at most 40 wt. % of a filler based on the total weight of the polyolefin, wherein the polyolefin comprises a polypropylene or a combination of polypropylene and polyethylene, wherein preferably the polyolefin comprises at least 45 wt. % of polypropylene based on the total weight of the polyolefin.

With “a combination of polypropylene and polyethylene” is meant a heterophasic propylene copolymer or polypropylene impact copolymer, which is a polypropylene blended with an elastomer impact modifier, such as polyethylene particles, C2-C8 (ethylene-octene copolymer) elastomer impact modifier or C2-C4 (ethylene-butene copolymer) impact modifier.

For example, the bonded structure can comprise a first polyolefin part and a second part, each independently comprising a polymer selected from the group consisting of: polypropylene, a combination of polypropylene and polyethylene, and combinations thereof. The polymer can be filled with a mineral filler, e.g., talc, or glass fibers, wherein the polymer comprises at most 45 wt. % of the filler, such as for example, at most 40 wt. % of the filler, based on the total weight of the polymer.

The first polyolefin part and the second part may comprise, for example, consist of the same polymer.

A burner can be used for producing the flame, said burner comprising at least one nozzle for providing a mixture of air and the propane-comprising gas to be burned, wherein the gap between the at least one nozzle and the bonding surface can easily be determined by the person skilled in the art. For example, the gap between the first bonding surface or second bonding surface, is, for example, between 5 cm and 15 cm, for example 8 cm. This gap influences the extent of activation accomplished by the flame-treatment. A too large distance between the cone of the flame and bonding surface, causes the surface activation to decrease. A too low distance between the cone of the flame and the bonding surface may damage the surface.

For example, a gap between the burner nozzle(s) and the surface of less than 5 cm can result in a surface energy of the activated polyolefin surface of, for example, from 34 to 60 mN/m, from 38 to 58 mN/m, or from 40 to 50 mN/m, determined in accordance with ISO 8296:2003. In contrast, a gap between the burner nozzle(s) and the surface within the disclosed range can result in a surface energy of the activated polyolefin e.g., polypropylene, surface, to be bonded to a second part using an acrylic structural adhesive, of higher than 30 and less than 34 mN/m, determined in accordance with ISO 8296:2003, the benefits of which are disclosed herein.

The temperature reached on the flame-treated first polyolefin bonding surface and/or flame-treated second boding surface, during treatment with a flame of a propane-comprising gas, can be between 30° C. and 90° C., preferably between 50° C. and 80° C., more preferably between 60° C. and 65° C.; for example, 60° C. At temperatures below 30° C. and above 90° C., the desired increase in surface energy, increase of the polar part of the surface energy and increase wettability of the bonding surface is not obtained, or the surface is over-treated. Preferably, the surface energy of said flame-treated first polyolefin bonding surface and/or flame-treated second polyolefin bonding surface is higher than 30 mN/m, determined in accordance with ISO 8296:2003, and the polar part of the surface energy is higher than 1.5 mN/m, preferably higher than 2 mN/m.

Activation of a polymer surface can be characterized by quantifying the changes on surface energy and wettability. Surface energy quantifies the disruption of intermolecular bonds that occur when a surface is created. Surface energy is the energy required to increase the size of the surface of a phase. It can be considered as having a polar and a disperse (or dispersive) part. Wettability is the ability of a liquid (e.g., water) to maintain contact with a solid surface. Wettability is generally determined by measuring is given by the contact angle of water with a surface.

Activation of a polymer surface can then lead to an increase of its surface energy, an increase of the polar part contributing to the surface energy, and/or a decrease of the contact angle of the surface with water.

Present understanding in the industry is that surface energies of plastics of 38 to 42 mN/m facilitate good adhesion conditions and that a surface energy of up to 72 mN/n are possible on many plastics.

The present inventors surprisingly discovered that a surface energy of the activated polyolefin e.g., polypropylene, surface of less than 34 mN/m, preferably less than or equal to 33 mN/m, determined in accordance with ISO 8296:2003, provides desirable adhesion to a second part using an acrylic structural adhesive. Surface energy values, determined in accordance with ISO 8296:2003, can be measured by Test ink Series C-Ethanol (dyne test, available from Rycobel).

The surface energy of the activated polyolefin e.g., polypropylene, surface can be, for example, higher than 30 to less than 34 mN/m, preferably 31 to 33 mN/m or 31 to 32 mN/m, determined in accordance with ISO 8296:2003. The surface energy of the activated polyolefin e.g., polypropylene, surface is more preferably higher than 31 mN/m, determined in accordance with ISO 8296:2003.

For example, a surface energy of less than 34 mN/m, determined in accordance with ISO 8296:2003, can allow for desirable adhesion of polypropylene, a material with intrinsically low surface energy, to a second part using an acrylic structural adhesive. A surface energy of, for example, 31 to 32 mN/m, determined in accordance with ISO 8296:2003, can lead to good initial adhesion and adhesion after extended conditioning, an indication of long term adhesion, as disclosed herein. While a surface energy of 35 mN/m and higher, determined in accordance with ISO 8296:2003, may provide good initial adhesion, a surface energy of 35 mN/m and higher, determined in accordance with ISO 8296:2003, can exhibit adhesion failure after extended conditioning, an indication of long term adhesion.

The flame-treatment speed may, for example, be between 200 mm/s and 1,200 mm/s, preferably between 250 mm/s and 1,000 mm/s, more preferably between 250 mm/s and 700 mm/s, such as, for example, 300 mm/s. Moreover, the total flow of gas and air mixture can be between 200 L/min and 750 L/min, preferably 450 L/min.

After surface activation, the polyolefin may achieve a surface chemistry that is favorable for further secondary operations and does not have a detrimental effect on long-term adhesion or on the original properties of the substrate. Creating a specific surface chemistry on the polyolefin can aid with achieving strong initial and long-term adhesion of adhesive systems, for long life expectancy and safety of automotive parts in real environment conditions.

The acrylic structural adhesive may be a single-component adhesive. This single-component adhesive can be a moisture-curing type adhesive, which contains an isocyanate-terminated prepolymer and which cures by reaction with moisture in the air.

The acrylic structural adhesive may be a two-component adhesive. A first component can comprise an adhesive resin component comprising methacrylate monomers, amines, and toughening agents and rubbers, and a second composite can comprise a peroxide-based activator paste. Upon combination of the first component and the second component, a chemical reaction takes place to form an acrylic structural adhesive.

Different types of acrylic structural adhesives include methyl methacrylate (MMA) acrylic, Low Odor acrylic, and low surface energy (LSE) acrylic.

The acrylic structural adhesive may be applied to the first flame-treated bonding surface and/or to the second bonding surface.

In an embodiment, the second part can comprise a polyolefin and the bond can have a lap shear strength according to DIN EN 1465:2009 of greater than or equal to 1.5 MPa or 1.75 MPa after conditioning for 168 hours at 23±2° C. and 50±6% relative humidity; the bond can have a lap shear strength according to DIN EN 1465:2009 of greater than or equal to 2.0 MPa or 2.25 MPa after conditioning for 168 hours at 23±2° C. and 50±6% relative humidity and being subjecting to heating and cooling cycles at various relative humidities; or a combination thereof.

The second part can comprise a metal, the second part may not be subjected to laser radiation, and the bond can have a lap shear strength according to DIN EN 1465:2009 of greater than or equal to 2.0 MPa or 2.25 MPa or 2.5 MPa after conditioning for 168 hours at 23±2° C. and 50±6% relative humidity; the bond can have a lap shear strength according to DIN EN 1465:2009 of greater than or equal to 6.0 MPa or 6.25 MPa or 6.5 MPa after conditioning for 168 hours at 23±2° C. and 50±6% relative humidity and being subjecting to heating and cooling cycles at various relative humidities; the bond can have a lap shear strength according to DIN EN 1465:2009 of greater than or equal to 6.0 MPa or 6.25 MPa or 6.5 MPa after conditioning for 168 hours at 23±2° C. and 50±6% relative humidity and being fully immersed in ethylene-glycol/water for 45 days at 65° C.; or a combination thereof.

In an embodiment, the second part can be a metal part, which can be an automotive part, for example, a part of a battery for a vehicle such as an electric vehicle. In an embodiment, the metal part is aluminum.

The present inventors surprisingly discovered that by using an acrylic structural adhesive, polyolefin and metal can be bonded without roughening the metal surface, such as by laser radiation into the metal surface. Prior to bonding, the metal surface can be cleaned with isopropyl alcohol.

A bonded structure can be obtained by the process according to the invention. Such bonded structure can, for example, be used as an automotive part, such as a tailgate or a roof spoiler or a bumper. When the second part is metal, the bonded structure can, for example, be used in a battery, for example, a battery of an electric vehicle.

In an embodiment, an electric vehicle comprises the bonded structure including a second part that is metal.

It is noted that the invention relates to all possible combinations of features described herein, preferred in particular are those combinations of features that are present in the claims.

It is further noted that the term “comprising” does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description of a process comprising certain steps also discloses a process consisting of these steps. The process consisting of these steps may be advantageous in that it offers a simpler, more economical process. When values are mentioned for a lower limit and an upper limit, ranges made by the combinations of the values of the lower limit and the values of the upper limit are also understood to be disclosed.

The term “automotive” or “automobile(s)” or “vehicle(s)” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The invention is now elucidated by way of the following examples, without however being limited thereto.

### EXAMPLES

The following examples are intended to explain the invention, not to limit the invention.

As specified above, the present invention is related to a method for the preparation of a bonded structure. The bonded structure is formed by bonding a first polyolefin part and a second part.

Different polypropylene (PP) samples were tested. A summary is provided in Table 1.

TABLE 1

| Sample | Description | Tradename | Manufacturer |
|---|---|---|---|
| 1 | 30% short glass fiber reinforced PP; base | SABIC ® | SABIC |
| | material is a PP homopolymer; the glass | PPCOMPOUND | |
| | fibers are chemically coupled to the PP | G3230A | |
| | matrix | | |
| 2 | Halogen free flame retardant, homopolymer | SABIC ® | SABIC |
| | with 15% glass fiber; UL94V0@3 mm | PPCOMPOUND | |
| | | H1015 | |
| 3 | Halogen free flame retardant, homopolymer | SABIC ® | SABIC |
| | with 30% glass fiber; UL94V0@1.5 mm and | PPCOMPOUND | |
| | 5VA@3.0 mm flame rating | H1030 | |
| 4 | 40% long glass fiber reinforced low | STAMAX ™ | SABIC |
| | emission grade; the glass fibers are | 40YM240E | |
| | chemically coupled to the PP matrix, | | |
| | resulting in high stiffness and strength | | |
| 5 | Halogen free flame retardant, copolymer | STAMAX ™ | SABIC |
| | with 30% long glass fiber; the glass fibers | 30YH570 | |
| | are chemically coupled to the PP matrix, | | |
| | resulting in high stiffness and strength | | |
| 6 | Mineral filled elastomer-modified | PPcompound | SABIC |
| | polypropylene | 8510E | |
| 7 | Polypropylene Homopolymer | PP 595A | SABIC |

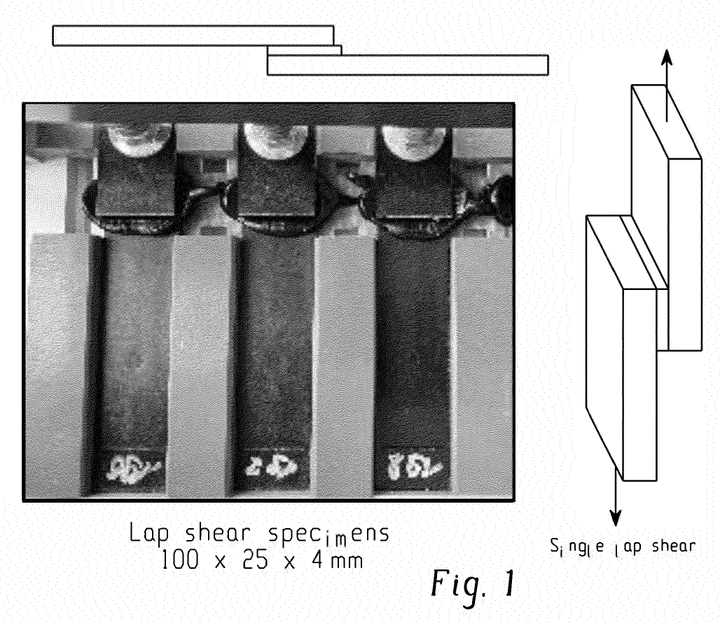

Adhesion lap tests were performed to examine the bonding behavior of bonded structures. FIG. 1 illustrates a setup for lap shear testing in accordance with the Examples. Lap shear specimens with dimensions 100×25×4 mm were used for lap shear test.

Bonded structures were subjected to different forms of conditioning. “Initial” conditioning involved conditioning for 168 hours at 23±2° C. and 50±6% relative humidity. Samples subjected to “extended” conditioning were first subjected to Initial conditioning followed by being subjected to heating and cooling cycles at various relative humidities. Samples subjected to “Ethylene-Glycol” or “E-G” conditioning were first subjected to Initial conditioning followed by being fully immersed in ethylene-glycol/water (50/50) for 45 days at 65° C.

Subsequently, lap shear tests according to DIN EN 1465:2009 (Determination of tensile lap-shear strength of bonded assemblies) were performed on each sample.

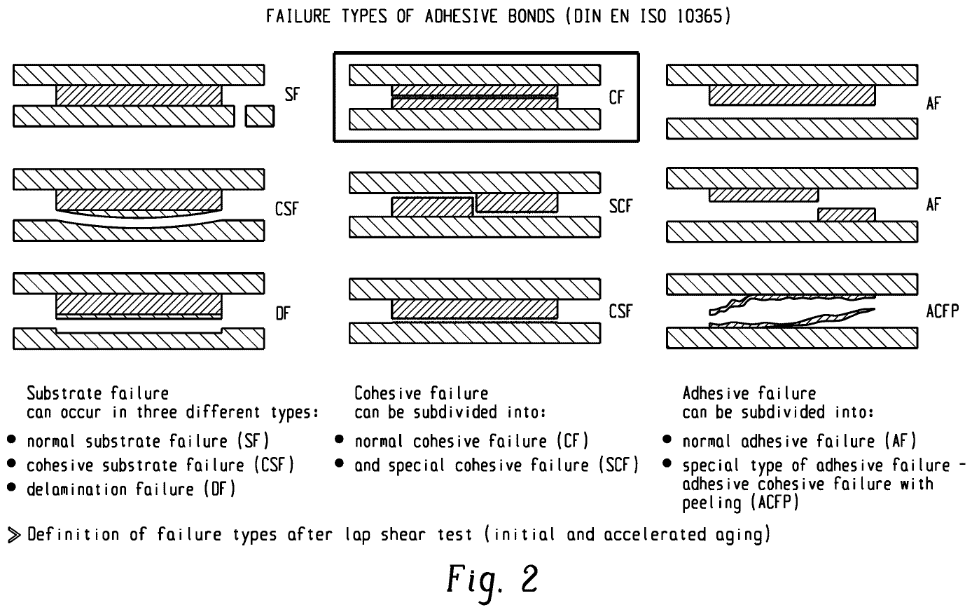

Failure analysis was carried out according to DIN EN ISO 10365. FIG. 2 illustrates failure types of adhesive bonds (DIN EN ISO 10365). As shown in FIG. 2, substrate failure can include normal substrate failure (SF), cohesive substrate failure (CSF), or delamination failure (DF). “Substrate failure” or “SF”, as used herein, means fracture of the bonded material on one of the bonded parts in the zone adjacent to the acrylic structural adhesive and approximately along the center of the plane of the acrylic structural adhesive locates perpendicular to the bonding surfaces, without internal breakdown of the acrylic structural adhesive. “Cohesive substrate failure” or “CSF”, as used herein, means fracture of the bonded material. There is an internal breakdown on one of the bonded parts in the zone adjacent to the adhesive and approximately along the center of the plane of the acrylic structural adhesive located parallel to both bonding surfaces, without internal breakdown of the acrylic structural adhesive.

Cohesive failure can be subdivided into normal cohesive failure (CF) and special cohesive failure (SCF). “Cohesive failure” or “CF”, as used herein, means fracture of the bonded material within the acrylic structural adhesive. There is an internal breakdown of the acrylic structural adhesive, and the breakdown takes place approximately along the center plane of the acrylic structural adhesive located parallel to both bonding surfaces. This is also known as normal cohesive failure. “Special cohesive failure” or “SCF”, as used herein, means fracture of the bonded material within the bonded parts. There is an internal breakdown of the bonded parts, with the particularity that the breakdown does not take place approximately along the center of the plane of the acrylic structural adhesive located parallel to both bonding surfaces; e.g., it can occur perpendicular to, or not approximately along, the center plane of the acrylic structural adhesive located parallel to both bonding surfaces.

“SCF/CF”, as used herein, means that the bonds between the acrylic structural adhesive and the bonded surfaces break exhibiting a combination of special cohesive failure and normal cohesive failure. More than 50% of the bonded area after de-bonding shows special cohesive failure.

Adhesive failure can be subdivided into normal adhesive failure (AF) and adhesive cohesive failure with peeling (ACFP). “Adhesive failure” or “AF”, as used herein, means that the bonds between the adhesive and the bonded surfaces break. The adhesive is retained on only one surface of the surfaces that were bonded.

“CF/AF”, as used herein, means that the bonds between the acrylic structural adhesive and the bonded surfaces break exhibiting a combination of cohesive failure and adhesive failure. There are areas of the bonded surfaces after de-bonding showing no residuals of the adhesive, and areas on the same bonded surface showing residuals of the adhesive. More than 50% of the bonded area after de-bonding shows a cohesive failure.

“AF/CF”, as used herein, means that the bonds between the acrylic structural adhesive and the bonded surfaces break exhibiting a combination of adhesive failure and cohesive failure. There are areas of the bonding surfaces after de-bonding showing no residuals of the adhesive, and areas on the same bonding surface showing residuals of the adhesive. More than 50% of the bonded area after de-bonding shows adhesive failure.

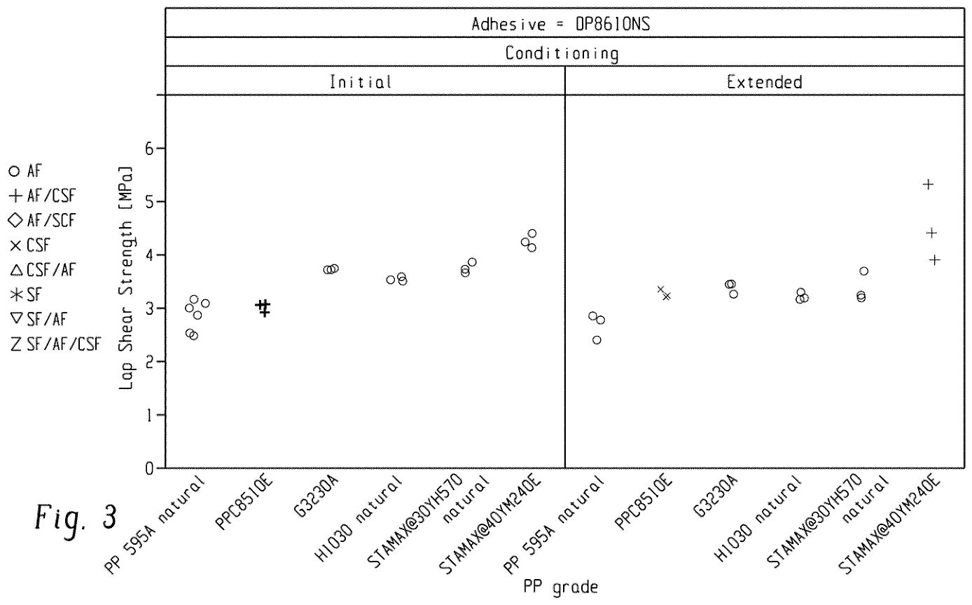

Table 2 present results of 3M™ Scotch-Weld™ Flexible Acrylic Adhesive DP8610NS (two-part acrylic structural adhesive) for two polypropylene parts including the same polypropylene bonded to one another. FIG. 3 is a graph showing the results of Table 2.

A first polypropylene (PP) part was flame-treated to provide an activated polypropylene surface, which was bonded to a second PP part using an acrylic structural adhesive. The flame-treatment included a total flow of gas and air mixture of 450 liters per minute (L/min), a gap between the burner nozzle(s) and the surface of 8 centimeters (cm), a flame-treatment speed of 300 millimeters per second (mm/s), 2 passes of the flame, and a gas to air volume ratio of 1:21.5 to 1:25. The surface energy of the activated polypropylene surface was less than 34 millinewtons per meter (mN/m).

TABLE 2

| | | Mean | Std Dev | |
|---|---|---|---|---|
| | | (Lap shear | (Lap shear | |
| | | strength | strength | |
| PP | Conditioning | (MPa)) | (MPa)) | Failure mode |
| Sample 1 | Initial | 3.73 | 0.02 | AF 100% |
| Sample 1 | Extended | 3.38 | 0.11 | AF 100% |
| Sample 3 | Initial | 3.54 | 0.04 | AF 100% |
| Sample 3 | Extended | 3.22 | 0.07 | AF 100% |
| Sample 4 | Initial | 4.26 | 0.13 | AF 100% |
| Sample 4 | Extended | 4.54 | 0.72 | AF/CSF 100% |
| Sample 5 | Initial | 3.75 | 0.11 | AF 100% |
| Sample 5 | Extended | 3.38 | 0.28 | AF 100% |
| Sample 6 | Initial | 3.02 | 0.05 | AF/CSF 100% |
| Sample 6 | Extended | 3.26 | 0.07 | CSF 100% |
| Sample 7 | Initial | 2.86 | 0.29 | AF 100% |
| Sample 7 | Extended | 2.68 | 0.24 | AF 100% |

In Table 2, “AF 100%” means that 100% of tested joints show adhesive failure. Mean lap shear strengths of 2.86-4.26 MPa were achieved with initial conditioning and mean lap shear strengths of 2.68-4.54 MPa were achieved with extended conditioning.

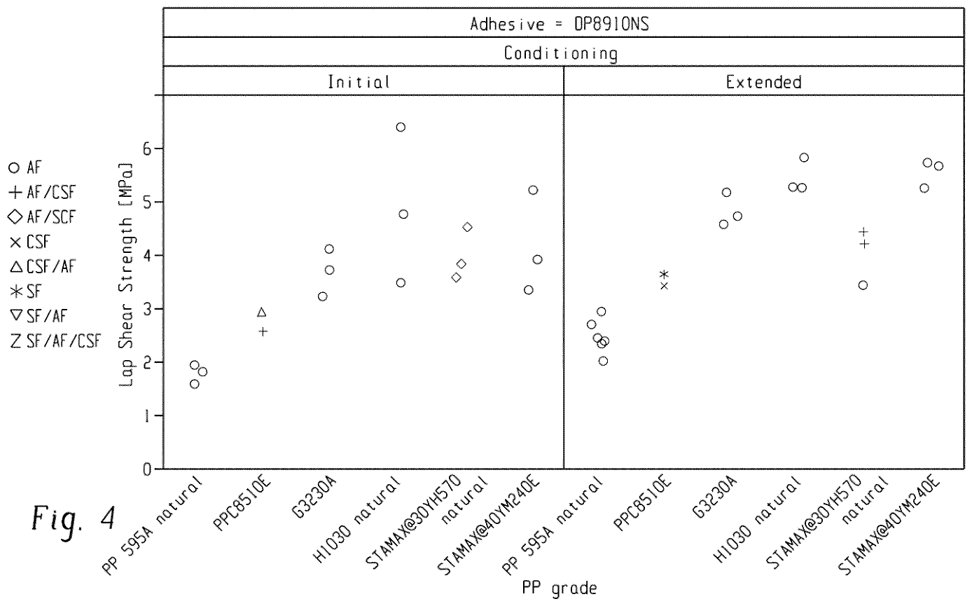

Table 3 present results of 3M™ Scotch-Weld™ Nylon Bonder Structural Adhesive DP8910NS (two-part structural acrylic adhesive) for two polypropylene parts including the same polypropylene bonded to one another. FIG. 4 is a graph showing the results of Table 3.

TABLE 3

| | | Mean | Std Dev | |
|---|---|---|---|---|
| | | (Lap shear | (Lap shear | |
| | | strength | strength | |
| PP | Conditioning | (MPa)) | (MPa)) | Failure mode |
| Sample 1 | Initial | 3.69 | 0.45 | AF 100% |
| Sample 1 | Extended | 4.83 | 0.31 | AF 100% |
| Sample 3 | Initial | 4.89 | 1.46 | AF 100% |
| Sample 3 | Extended | 5.45 | 0.32 | AF 100% |
| Sample 4 | Initial | 4.16 | 0.96 | AF 100% |
| Sample 4 | Extended | 5.56 | 0.26 | AF 100% |
| Sample 5 | Initial | 3.98 | 0.49 | AF/SCF 100% |
| Sample 5 | Extended | 4.03 | 0.53 | AF/CSF 67%, |
| | | | | AF 33% |
| Sample 6 | Initial | 2.82 | 0.21 | CSF/AF 67%, |
| | | | | AF/CSF 33% |
| Sample 6 | Extended | 2.36 | 2.04 | SF 50%, |
| | | | | CSF 50% |
| Sample 7 | Initial | 1.78 | 0.18 | AF 100% |
| Sample 7 | Extended | 2.48 | 0.32 | AF 100% |

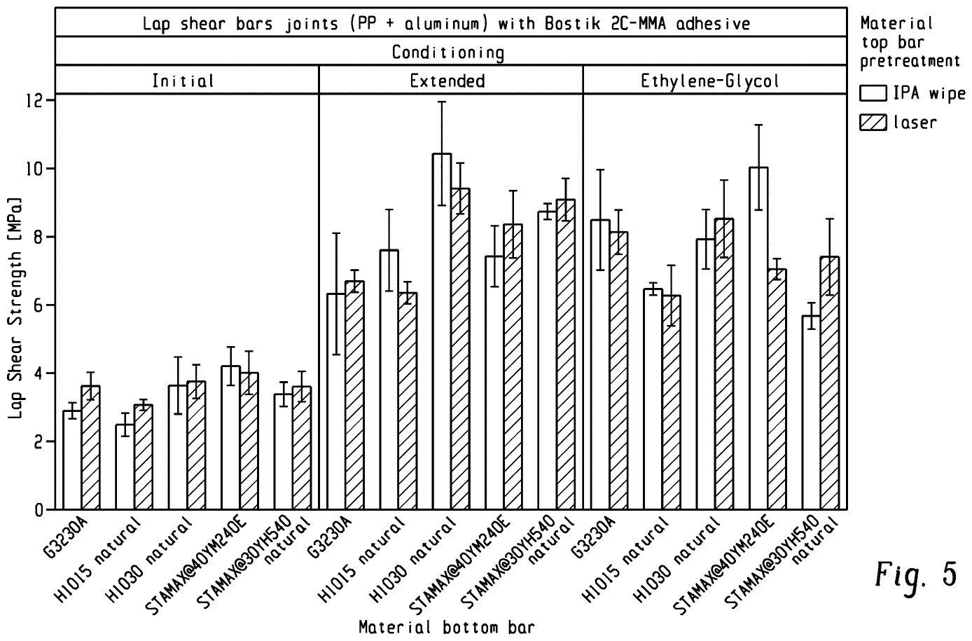

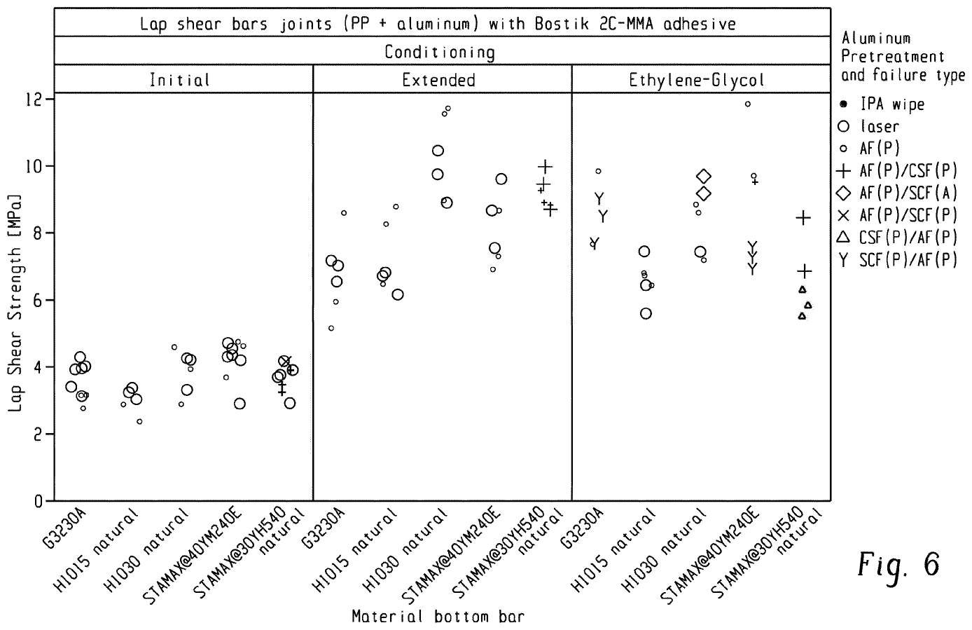

Mean lap shear strengths of 1.78-4.89 MPa were achieved with initial conditioning and mean lap shear strengths of 2.36-5.56 MPa were achieved with extended conditioning. Table 4 presents results for samples bonded using SAF Ultimate 15 (two-part) methacrylate adhesive from BOSTIK. Different polypropylene samples were bonded to aluminum parts. Prior to application of adhesive the aluminum surface to be bonded was wiped with isopropyl alcohol (IPA)) or roughened by laser radiation. During testing, the polypropylene was on top and the aluminum part was on the bottom. FIG. 5 and FIG. 6 are graphs showing the results of Table 4.

The PP samples were flame-treated to provide an activated polypropylene surface, which was bonded to the aluminum part using an acrylic structural adhesive. The flame-treatment included a total flow of gas and air mixture of 450 liters per minute (L/min), a gap between the burner nozzle(s) and the surface of 8 centimeters (cm), a flame-treatment speed of 300 millimeters per second (mm/s), 2 passes of the flame, and a gas to air volume ratio of 1:21.5 to 1:25. The surface energy of the activated polypropylene surface was less than 34 millinewtons per meter (mN/m).

TABLE 4

| | | | Mean (Lap | Std Dev (Lap | |
|---|---|---|---|---|---|
| | | | shear | shear | |
| | Al | | strength | strength | |
| PP | treatment | Conditioning | (MPa)) | (MPa)) | Failure mode |
| Sample 1 | IPA | Initial | 3.02 | 0.23 | AF(P) 100% |
| Sample 1 | laser | Initial | 3.80 | 0.44 | AF(P) 100% |
| Sample 1 | IPA | Extended | 6.63 | 1.84 | AF(P) 100% |
| Sample 1 | laser | Extended | 6.98 | 0.33 | AF(P) 100% |
| Sample 1 | IPA | E-G | 8.85 | 1.55 | AF(P) 100% |
| Sample 1 | laser | E-G | 8.51 | 0.68 | SCF(P)/AF(P) 100% |
| Sample 2 | IPA | Initial | 2.62 | 0.37 | AF(P) 100% |
| Sample 2 | laser | Initial | 3.22 | 0.16 | AF(P) 100% |
| Sample 2 | IPA | Extended | 7.92 | 1.23 | AF(P) 100% |
| Sample 2 | laser | Extended | 6.63 | 0.35 | AF(P) 100% |
| Sample 2 | IPA | E-G | 6.72 | 0.19 | AF(P) 100% |
| Sample 2 | laser | E-G | 6.56 | 0.94 | AF(P) 100% |
| Sample 3 | IPA | Initial | 3.82 | 0.88 | AF(P) 100% |
| Sample 3 | laser | Initial | 3.94 | 0.53 | AF(P) 100% |
| Sample 3 | IPA | Extended | 10.87 | 1.57 | AF(P) 100% |
| Sample 3 | laser | Extended | 9.81 | 0.79 | AF(P) 100% |
| Sample 3 | IPA | E-G | 8.30 | 0.91 | AF(P) 100% |
| Sample 3 | laser | E-G | 8.87 | 1.20 | AF(P)/SCF(A) 67%, |
| | | | | | AF(P) 33% |
| Sample 4 | IPA | Initial | 4.38 | 0.59 | AF(P) 100% |
| Sample 4 | laser | Initial | 4.18 | 0.66 | AF(P) 100% |
| Sample 4 | IPA | Extended | 7.71 | 0.94 | AF(P) 100% |
| Sample 4 | laser | Extended | 8.70 | 1.05 | AF(P) 100% |
| Sample 4 | IPA | E-G | 10.49 | 1.32 | AF(P) 67%, |
| | | | | | AF(P)/CSF(P) 33% |
| Sample 4 | laser | E-G | 7.34 | 0.32 | SCF(P)/AF(P) 100% |
| Sample 5 | IPA | Initial | 3.57 | 0.33 | AF(P)/CSF(P) 100% |
| Sample 5 | laser | Initial | 3.78 | 0.47 | AF(P) 84%, |
| | | | | | AF(P)/SCF(P) 16% |
| Sample 5 | IPA | Extended | 9.12 | 0.24 | AF(P)/CSF(P) 100% |
| Sample 5 | laser | Extended | 9.50 | 0.64 | AF(P)/CSF(P) 100% |
| Sample 5 | IPA | E-G | 5.95 | 0.40 | CSF(P)/AF(P) 100% |
| Sample 5 | laser | E-G | 7.74 | 1.16 | AF(P)/CSF(P) 100% |

Mean lap shear strengths of 2.62-4.38 MPa were achieved with initial conditioning and IPA Al treatment, mean lap shear strengths of 6.63-10.87 MPa were achieved with extended conditioning and IPA Al treatment, and mean lap shear strengths of 6.72-10.49 MPa were achieved with ethylene-glycol conditioning and IPA Al treatment.

Comparable results of lap shear strength for lap shear bar joints were achieved with cleaning with IPA as compared to the complex and expensive process of roughening by laser radiation. In some instances, better results were achieved with cleaning with isopropyl alcohol as compared to the complex and expensive process of roughening by laser radiation. Such results that were achieved without laser radiation involved use of an acrylic structural adhesive without primer to bond an activated polyolefin surface.

All examples clearly show that the process for the preparation of a bonded structure according to the invention comprises at least one flame-treated bonding surface, which is an activated surface having increased surface energy, increased polarity and lower contact angle with water. The combination of all these characteristics leads to a bonding surface that has improved adherence with an acrylic structural adhesive, which results in a bonded structure having higher adhesion shear strength.

One or more objects of the present invention are obtained by the embodiments cited above and in the appended claims.

1. A process for preparing of a bonded structure comprising:
flame-treating a surface of a first part comprising a polyolefin to provide an activated polyolefin surface;
directly applying an acrylic structural adhesive to the activated polyolefin surface and a surface of a second part; and
curing the adhesive to form a bond between the first part and the second part.

2. The process of claim 1, wherein the acrylic structural adhesive comprises methacrylate.

3. The process of claim 1, wherein the polyolefin comprises a polypropylene.

4. The process of claim 1, wherein the polyolefin comprises a polyethylene.

5. The process of claim 1, wherein the first part further comprises glass fiber, a flame retardant additive, or a combination thereof.

6. The process of claim 1, wherein the second part comprises a polyolefin and wherein the bond has a lap shear strength according to DIN EN 1465:2009 of
greater than or equal to 1.5 megapascals or 1.75 megapascals after conditioning for 168 hours at 23±2° C. and 50±6% relative humidity,
greater than or equal to 2.0 megapascals or 2.25 megapascals after conditioning for 168 hours at 23±2° C. and 50±6% relative humidity and being subjecting to heating and cooling cycles at various relative humidities, or
a combination thereof.

7. The process of claim 1, wherein the second part comprises a polypropylene.

8. The process of claim 1, wherein the second part comprises a polyethylene.

9. The process of claim 1, wherein the second part comprises a metal.

10. The process of claim 9, wherein the second part is not subjected to laser radiation and wherein the bond has a lap shear strength according to DIN EN 1465:2009 of
greater than or equal to 2.0 megapascals or 2.25 megapascals or 2.5 megapascals after conditioning for 168 hours at 23±2° C. and 50±6% relative humidity,
greater than or equal to 6.0 megapascals or 6.25 megapascals or 6.5 megapascals after conditioning for 168 hours at 23±2° C. and 50±6% relative humidity and being subjecting to heating and cooling cycles at various relative humidities,
greater than or equal to 6.0 megapascals or 6.25 megapascals or 6.5 megapascals after conditioning for 168 hours at 23±2° C. and 50±6% relative humidity and being fully immersed in ethylene-glycol/water for 45 days at 65° C., or
a combination thereof.

11. The process of claim 1, wherein said propane-comprising gas comprising at least 80 wt. % of propane based on a weight of the propane-comprising gas, wherein, during treatment with the flame of the propane-comprising gas, a flame is produced by burning a mixture of air and the propane-comprising gas.

12. The process of claim 1, wherein, during flame-treatment with the flame of the propane-comprising gas, a volume ratio of propane to oxygen volume ratio is equal to or less than 1:5.01.

13. The process of claim 1, wherein the activated polyolefin surface has a surface energy of less than 34 millinewtons per meter, determined in accordance with ISO 8296:2003.

14. The process of claim 1, wherein the acrylic structural adhesive comprises two components.

15. A bonded structure prepared by the process of claim 1.
